(19) United States
(12) Patent Application Publication
(10) Pub. No.: US 2020/0376974 A1
(43) Pub. Date: Dec. 3, 2020

(54) AUTONOMOUS MOBILE VEHICLE CHARGER SYSTEM UTILIZING NOVEL STRUCTURAL ARCHITECTURE TO TRANSPORT AND DELIVER ENERGY TO A DENSELY POSITIONED ARRAY OF ENERGY USERS

(71) Applicant: c/o GM Global Technology Operations LLC, Detroit, MI (US)

(72) Inventors: Charles E. Freese, V, Ira Township, MI (US); William H. Pettit, Rochester, NY (US); Margarita M. Mann, Royal Oak, MI (US); Matthew C. Kirklin, Lake Orion, MI (US); Alan B. Martin, Washington, MI (US)

(73) Assignee: c/o GM Global Technology Operations LLC, Detroit, MI (US)

(21) Appl. No.: 16/424,080

(22) Filed: May 28, 2019

(51) Int. Cl. B60L 53/37; G05D 1/02; G05D 1/00

(52) U.S. Cl. CPC B60L 53/37; G05D 2201/02; G05D 1/0088; G05D 1/0238

(57) ABSTRACT

A system for charging an electric vehicle includes an autonomous vehicle. The autonomous vehicle includes a suspended body, a plurality of elongated legs configured to enable the autonomous vehicle to maneuver around obstacles in a parking structure and to enable the suspended body to be suspended over the electric vehicle, a charging system configured to charge the electric vehicle, and a plurality of sensors acquiring data regarding an environment around the autonomous vehicle. The autonomous vehicle includes programming to utilize the data regarding the environment around the autonomous vehicle to automatically move to the electric vehicle.

### INTRODUCTION

The disclosure generally relates to a system and method for operating an autonomous mobile charger useful to recharge electric vehicles.

Fuel cells are electrochemical devices which combine a fuel such as hydrogen and an oxidant such as oxygen to produce electricity. The term “fuel cell” is typically used to refer to either a single cell or a plurality of cells depending upon the context in which it is used. The plurality of cells is typically bundled together and arranged to form a stack with the plurality of cells commonly arranged in electrical series.

Different fuel cell types may be provided such as phosphoric acid, alkaline, molten carbonate, solid oxide, and proton exchange membrane (PEM), for example. The basic components of a PEM-type fuel cell are two electrodes separated by a polymer membrane electrolyte. Each electrode is coated on one side with a thin catalyst layer. The electrodes, catalyst, and membrane together form a membrane electrode assembly (MEA).

Electric vehicles have a range defined by the limited energy storage capacity of the vehicle. If the vehicle is battery powered, the vehicle will move so long as the energy storage device(s) of the vehicle may provide a minimum power to the electric machine(s) used to propel the vehicle. Energy storage devices may be recharged regularly to permit the vehicle to refresh its maximum available range.

Autonomous vehicles are vehicles that move around an environment based upon programmed instructions. Autonomous vehicles may move on a roadway, in a warehouse, or within a parking structure. Autonomous vehicles monitor inputs, such as images captured by a camera, radar data, LIDAR data, ultrasonic data, and data from other sources in the art to determine where the vehicle may travel and where it may not. The autonomous vehicles include computerized processors that use the inputs along with programmed instructions to navigate the vehicle to accomplish programmed tasks or goals.

Robotic units similarly in the art move articulated features such as robotic arms in an environment. Such robotic units may similarly monitor inputs such as images captured by a camera, radar data, LIDAR data, ultrasonic data, and data from other sources in the art to determine how the articulated features may move to accomplish programmed tasks or goals.

### SUMMARY

A system for charging an electric vehicle includes an autonomous vehicle is provided. The autonomous vehicle includes a suspended body, a plurality of elongated legs configured to enable the autonomous vehicle to maneuver around obstacles in a parking structure and to enable the suspended body to be suspended over the electric vehicle, a charging system configured to charge the electric vehicle, and a plurality of sensors acquiring data regarding an environment around the autonomous vehicle. The autonomous vehicle includes programming to utilize the data regarding the environment around the autonomous vehicle to automatically move to the electric vehicle.

In one or more embodiments, the charging system includes a hydrogen tank and a fuel cell to convert hydrogen fuel from the hydrogen tank into energy to charge the electric vehicle.

In one or more embodiments, the charging system further includes an energy storage device.

In one or more embodiments, the charging system further includes an energy storage device.

In one or more embodiments, the plurality of elongated legs are selectively extendable and selectively retractable in a vertical direction.

In one or more embodiments, the plurality of elongated legs are selectively extendable and selectively retractable in a horizontal direction.

In one or more embodiments, the plurality of elongated legs are selectively extendable and selectively retractable in a horizontal direction.

In one or more embodiments, the autonomous vehicle further includes a charging tether articulating arm configured to connect the charging system to the electric vehicle.

In one or more embodiments, the autonomous vehicle further includes a plurality of charging tether articulating arms configured to connect the charging system to a plurality of electric vehicles.

In one or more embodiments, the autonomous vehicle further includes a plurality of charging tethers configured to connect the charging system to a plurality of electric vehicles.

In one or more embodiments, the charging system includes a separable charging system configured to separate from the autonomous vehicle and remain with the electric vehicle through a charging cycle, and the autonomous vehicle includes a deployment arm.

In one or more embodiments, the autonomous vehicle further includes a plurality of separable charging systems.

In one or more embodiments, the plurality of elongated legs includes two elongated legs, and the autonomous vehicle further includes programming to maintain a center of gravity of the autonomous vehicle above a center of the two elongated legs

A system for charging an electric vehicle is provided and includes an autonomous vehicle including a suspended body, a plurality of elongated legs configured to enable the autonomous vehicle to maneuver around obstacles in a parking structure and to enable the suspended body to be suspended over the electric vehicle and wherein the plurality of elongated legs are selectively extendable and selectively retractable in a vertical direction, a charging system configured to charge the electric vehicle, a plurality of sensors acquiring data regarding an environment around the autonomous vehicle, and a charging tether articulating arm configured to connect the charging system to the electric vehicle, wherein the autonomous vehicle includes programming to utilize the data regarding the environment around the autonomous vehicle to automatically move to the electric vehicle.

In one or more embodiments, the charging system includes a hydrogen tank and a fuel cell to convert hydrogen fuel from the hydrogen tank into energy to charge the electric vehicle.

In one or more embodiments, the charging system further includes an energy storage device.

In one or more embodiments, the charging system includes an energy storage device.

A method for charging an electric vehicle is provided and includes, within an autonomous vehicle equipped with a plurality of elongated legs configured to enable the autonomous vehicle to maneuver around obstacles in a parking structure and wherein the elongated legs are selectively extendable and selectively retractable in a vertical direction, monitoring a plurality of sensors acquiring data regarding an environment around the autonomous vehicle, maneuvering the autonomous vehicle based upon the data from the plurality of sensors such that a suspended body of the autonomous vehicle is over the electric vehicle, and utilizing a charging tether articulating arm to connect the autonomous vehicle to the electric vehicle.

In one or more embodiments, the method further includes retracting the elongated legs when the autonomous vehicle is moving to the electric vehicle.

In one or more embodiments, the method further includes extending the elongated legs when the autonomous vehicle is approaching the electric vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates an exemplary autonomous mobile vehicle charger system embodied as an autonomous vehicle equipped with a charging system, in accordance with the present disclosure;

FIG. 2 illustrates an exemplary embodiment of an autonomous vehicle with two elongated legs, in accordance with the present disclosure;

FIG. 3 illustrates an exemplary embodiment of an autonomous vehicle with three elongated legs, in accordance with the present disclosure;

FIG. 4 illustrates a portion of an autonomous vehicle equipped with a charging system, including an extendable elongated leg configured to be extended in a vertical direction in a retracted state, in accordance with the present disclosure;

FIG. 5 illustrates the portion of the autonomous vehicle of FIG. 4, with the extendable elongated leg in an extended state, in accordance with the present disclosure;

FIG. 6 illustrates a portion of an autonomous vehicle equipped with a charging system, including an extendable elongated leg configured to be extended in a vertical direction and configured to be extended in a horizontal direction, with a horizontal adjustment arm being illustrated in a retracted state, in accordance with the present disclosure;

FIG. 7 illustrates the portion of the autonomous vehicle of FIG. 6, with the horizontal adjustment arm in an extended state, in accordance with the present disclosure;

FIG. 8 illustrates an exemplary wheel attached to an elongated leg of an autonomous vehicle, with an external electric machine attached to the elongated leg and providing motive force to the wheel, in accordance with the present disclosure;

FIG. 9 illustrates an exemplary embodiment of an autonomous mobile vehicle charger system communication and control architecture, in accordance with the present disclosure;

FIG. 10 illustrates an exemplary charging control module including a computerized processor operating the disclosed fuel cell stack thermal management system, in accordance with the present disclosure; and

FIG. 11 illustrates an autonomous vehicle deploying a plurality of separable charging systems, the charging systems each being configured to provide power to charge an electric vehicle, in accordance with the present disclosure.

### DETAILED DESCRIPTION

An electric vehicle utilizes a charger regularly to maintain a energy storage device state of charge (SOC) to provide power to on-vehicle electric machines providing motive force to the electric vehicle. Chargers take a number of forms. Fixed chargers include a charging unit fixed in location and typically attached to an electric power grid. Mobile chargers may include a fuel cell stack and hydrogen fuel storage useful to convert hydrogen fuel into power that may be utilized to recharge a vehicle. Additionally or alternatively, mobile chargers may include an on-board energy storage device which stores energy which may be subsequently transferred to an electric vehicle being recharged. Additionally or alternatively, mobile chargers may include a renewable energy source, such as a solar panel or a wind turbine, which may be used to generate energy in a renewable energy storage device, which may be subsequently transferred to an electric vehicle being recharged.

Electric vehicles may be recharged while the vehicle is in transit. For example, a user on a route home from work may stop at a charger and have a cup of coffee while the charger supplies energy to the electric vehicle. However, such recharging events take time, and many users are dissatisfied by having to wait while the vehicle recharges. Chargers are installed at some workplaces and some parking facilities, which is more convenient for users, because the user may multi-task while the vehicle is charging, for example, by going to work, shopping, or other similar activities. However, the number of chargers are limited and installing new additional chargers may be cost prohibitive. For example, if electric vehicles become prevalent, the cost of installing chargers at every parking location within a parking structure and maintaining those chargers may cost more than the parking structure originally cost.

An autonomous mobile vehicle charger system may be used to charge a large number of vehicles without requiring a dedicated charger to each vehicle or for each parking spot. For example, such an autonomous mobile vehicle charger system could be utilized in a parking structure or in a parking lot to travel from vehicle to vehicle, providing charge to each vehicle. Such an autonomous mobile vehicle charger system may include an autonomous vehicle including charging hardware, which may include one or more fuel cell stacks with corresponding hydrogen storage, an energy storage device, a renewable energy source, other charging hardware in the art, or a combination thereof.

Some parking facilities, for example, in sparsely populated areas, may include wide parking spots where vehicles are spaced regularly and with wide aisles providing access for an autonomous vehicle to access each parked electric vehicle that is to be charged. Other parking facilities pose a greater challenge, for example, in densely populated urban areas where vehicles are packed in closely with each other. In such an exemplary condition, using a typical autonomous vehicle equipped with a charger may be difficult to use, with many such autonomous vehicles being unable to access electric vehicle charger ports between tightly packed parked electric vehicles. While a smaller autonomous vehicle could be utilized to navigate through the tight spaces between the vehicles, a capacity of a charger to charge a plurality of vehicles depends upon the charging equipment on the autonomous vehicle having sufficient capacity. While an autonomous vehicle may be miniaturized to fit in small spaces between densely packed parked vehicles, if such charging equipment is similarly miniaturized, the capacity of the autonomous vehicle to charge parked electric vehicles will be severely limited or impractical.

An autonomous mobile vehicle charger system is provided, wherein the autonomous vehicle and accompanying charging equipment is suspended above the ground by a plurality of elongated legs. Throughout the disclosure, the legs will be discussed as having wheels on the bottom of the legs, but it will be appreciated that the legs may additionally or alternatively be equipped with tracks, or other mobility features which enable the autonomous vehicle to move relative to the ground. In another embodiment, the legs may additionally or alternatively be articulated to permit a walking-like motion of the legs. At least one of the wheels is attached to an electric machine onboard the autonomous vehicle providing motive force to propel the autonomous vehicle. In one embodiment, more of the wheels attached to the legs of the autonomous vehicle are attached to dedicated electric machines, such that the autonomous vehicle may be as maneuverable as possible, optimizing the autonomous vehicle for moving between densely packed parked vehicles.

The elongated legs of the autonomous vehicle equipped with charging equipment may be configured to be as thin as practically implemented, thereby enabling the autonomous to most effectively travel between densely packed parked vehicles. Maneuvering the legs of the autonomous vehicle between the parked vehicles may be accomplished by utilizing a plurality of sensors around the autonomous vehicle. In one embodiment, each leg of the autonomous vehicle may include dedicated sensors, for example, one or more camera devices, one or more radar devices, one or more LIDAR devices, or other similar sensor devices in the art capable of being utilized by one or more computerized processors to determine where the leg or legs of the autonomous vehicle may be maneuvered.

Camera devices in the art may be used with image recognition software and other programmed code to analyze images and determine locations and boundaries of objects; geometries of parking spaces; parking structure columns, ramps, walls, and other features; and presence of pedestrians, drivers, pets, children, and other occupants of space within and around parked vehicles. Similarly, radar devices utilize electromagnetic radiation emitters and study returns from electromagnetic radiation bouncing off of nearby objects to determine shapes of and distances between objects in the proximate environment of the radar device. LIDAR devices are similar to radar devices, with the exception that a LIDAR device utilizes a laser light emitter, and the LIDAR device utilizes a sensor to analyze the laser light bouncing off of objects in the proximate environment of the LIDAR device. Ultrasonic devices are similar to radar devices and LIDAR devices, with the exception that an ultrasonic device utilizes a high-pitched sound emitter, and the ultrasonic device utilizes a sensor to analyze the high-pitched sounds bouncing off of objects in the proximate environment of the ultrasonic device.

By utilizing sensors positioned around the autonomous vehicle equipped with a charger, a computerized processor may utilize programmed instructions in combination with inputs from the sensors to command movement of each of the legs of the autonomous vehicle such that the legs may be moved between parked vehicles. While the legs of the autonomous vehicle may be configured to be as thin as possible to maximize maneuverability around and between the parked vehicles, a suspended body of the autonomous vehicle above the legs may include charging equipment useful to charge parked electric vehicles. Such charging equipment on the suspended body may be scaled based upon how many vehicles are to be charged in sequence without the autonomous vehicle returning to a base station to be recharged or refueled.

The legs of the autonomous vehicle may be of fixed length. In some embodiments, the legs of the autonomous vehicle may be extendable and retractable, either in a vertical direction or a horizontal direction. For example, when being used to charge a parked electric vehicle, the legs of the autonomous vehicle may be extended vertically, such that the suspended body of the autonomous vehicle may be suspended over the electric vehicle being charged or suspended over a neighboring parked vehicle. When the autonomous vehicle is instead transiting from one location to another, for example, traveling from one vehicle to a second vehicle within a parking structure, the legs of autonomous vehicle may be vertically retracted to improve stability of the autonomous vehicle. Legs of the vehicle may additionally or alternatively be extendable or retractable horizontally, for example, permitting the autonomous vehicle to maneuver around odd shapes, parked vehicles parked at odd angles, or otherwise enable the legs of the vehicle articulate around densely packed parked vehicles. Alternatively or additionally, the legs may be articulatable, for example, either permitting a leg to be lifted, tilted, or otherwise manipulated to increase maneuverability of the autonomous vehicle. In such instances, a computerized processor may use sensor inputs and programmed instructions to maintain a balance of the unit, for example, positioning legs remaining on the ground to adequately support the suspended body of the autonomous vehicle if another leg of the autonomous vehicle needs to be lifted. An exemplary method of use may include retracting the elongated legs when the autonomous vehicle is moving to the electric vehicle and extending the elongated legs when the autonomous vehicle is approaching the electric vehicle.

An autonomous vehicle including charging equipment may include two legs, three legs, four legs, or more than four legs. An autonomous vehicle including two legs may utilize a computerized processor utilizing sensor inputs and programmed instructions to maintain a balance of the unit, for example, utilizing electric machines aboard the autonomous vehicle and maintaining a center of gravity of the autonomous vehicle above a center of the two legs.

An autonomous vehicle equipped with elongated legs can monitor sensor data from a plurality of sensors, and, based upon the data from the plurality of sensors, approach an electric vehicle and suspend a suspended body of the autonomous vehicle over the electric vehicle in order to provide a charging cycle to the electric vehicle.

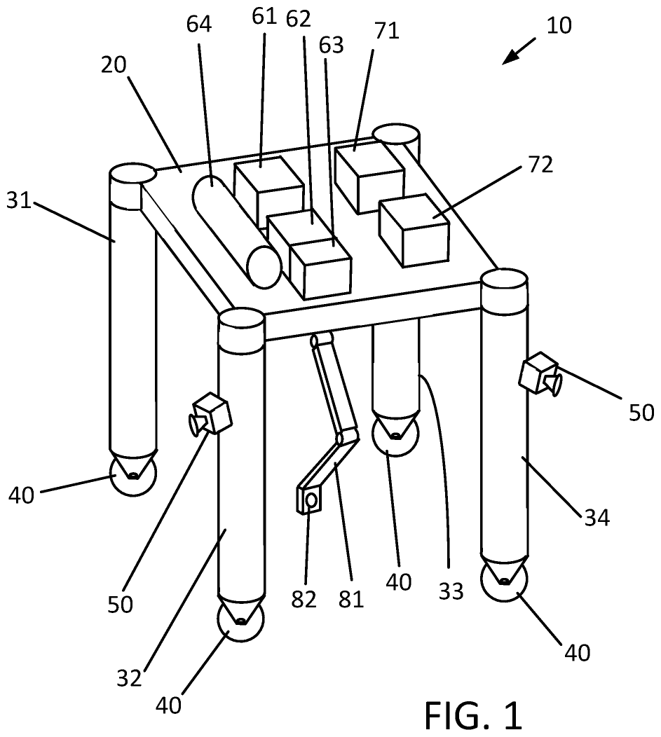

FIG. 1 illustrates an exemplary autonomous mobile vehicle charger system embodied as an autonomous vehicle equipped with a charging system. Autonomous vehicle 10 is illustrated including a suspended body 20 and elongated leg 31, elongated leg 32, elongated leg 33, and elongated leg 34. Each of elongated leg 31, elongated leg 32, elongated leg 33, and elongated leg 34 are illustrated including a wheel 40. At least one wheel 40 is equipped to provide motive force to autonomous vehicle 10. In one embodiment, two of wheels 40 are equipped to provide motive force to autonomous vehicle 10. In another embodiment, four of wheels 40 are equipped to provide motive force to autonomous vehicle 10. Wheels 40 may each be locked in an angular orientation in relation to autonomous vehicle 10, or wheels 40 may each be rotatable, providing steering for autonomous vehicle 10. Exemplary sensors 50 are illustrated attached to elongated leg 32 and elongated leg 34. It will be appreciated that a plurality of sensors may be used to enable a computerized processor of autonomous vehicle 10 to maneuver around other vehicle, interact with vehicles to be charged, and avoid moving vehicles, pedestrians, and other obstacles in the environment of autonomous vehicle 10. Elongated leg 31, elongated leg 32, elongated leg 33, and elongated leg 34 are configured to suspend elongated body 20 over an electric vehicle to be charged.

Suspended body 20 is illustrated with a charging control module 61, fuel cell system 62, fuel cell energy storage device 63, and hydrogen storage tank 64 or hydrogen tank attached to suspended body 20. Further, suspended body 20 is illustrated with a vehicle control module 71 and a vehicle energy storage device 72 attached to suspended body 20. Fuel cell system 62 which includes a fuel cell. The illustrated system would additionally include power electrics. Fuel cell energy storage device 63 and vehicle energy storage device 72 are illustrated. It will be appreciated that, in a different embodiment, a single exemplary energy storage device could be used for both purposes.

Charging tether articulating arm 81 and charging tether electric vehicle interface 82 are illustrated attached to autonomous vehicle 10. It will be appreciated that charging tether articulating arm 81 may be attached at various point around autonomous vehicle 10, and that multiple charging tether articulating arms 81 may be attached to a single autonomous vehicle 10. Charging tether electric vehicle interface 82 is attached to an end of charging tether articulating arm 81 and has connection features configured to interface with a charging port on an electric vehicle to be charged. Autonomous vehicle 10, in one embodiment, may have different charging tether articulating arms 81 with different charging tether electric vehicle interface 82 for different models of electric vehicles to be recharged. Charging tether electric vehicle interface 82 may include an ability to provide power to an electric vehicle and may include a data connection with the vehicle to transfer information such as a current SOC for the electric vehicle's energy storage device.

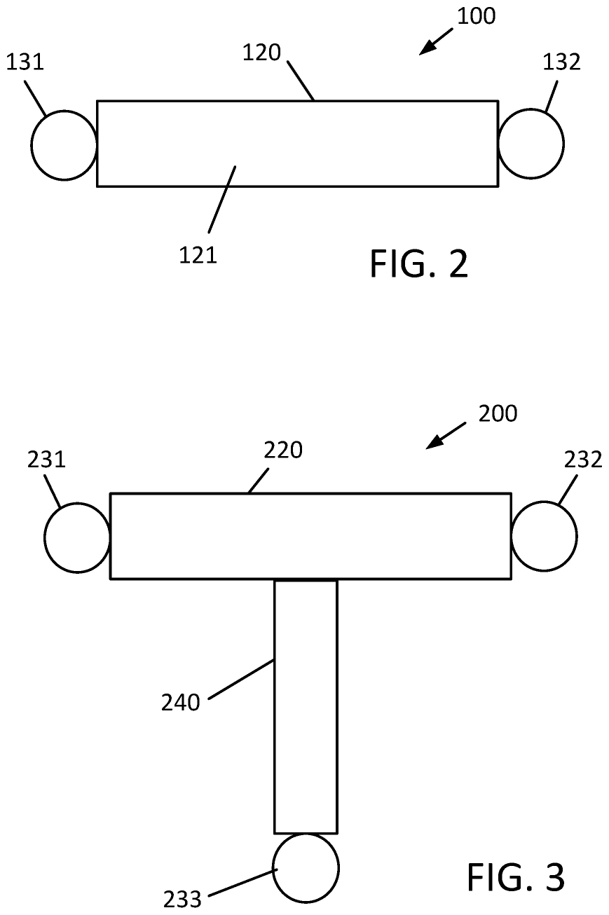

FIG. 1 illustrates an exemplary embodiment of an autonomous vehicle with four elongated legs. FIG. 2 illustrates an exemplary embodiment of an autonomous vehicle with two elongated legs. Autonomous vehicle 100 is illustrated including elongated leg 131 and elongated leg 132. Suspended body 120 is illustrated connected to both elongated leg 131 and elongated leg 132. Components of the charging system and the vehicular system are attached to suspended body 120, are covered by suspended body cover housing 121, and are not visible externally. Autonomous vehicle 100 may utilize a computerized processor utilizing sensor inputs and programmed instructions to maintain a balance of the unit, for example, utilizing electric machines aboard autonomous vehicle 100 and maintaining a center of gravity of autonomous vehicle 100 above a center of elongated leg 131 and elongated leg 132.

FIG. 3 illustrates an exemplary embodiment of an autonomous vehicle with three elongated legs. Autonomous vehicle 200 is illustrated including elongated leg 231 and elongated leg 232 connected by an attached suspended body 220. Third leg connection arm 240 is illustrated attached to suspended body 220, and elongated leg 233 is illustrated connected to third leg connection arm 240. In one embodiment, third leg connection arm 240 may be formed unitarily with suspended body 220 an be indistinguishable there from. Components of the charging system and the vehicular system are attached to suspended body 220, third leg connection arm 240, or some combination thereof. In an alternative embodiment, a charger could roll on a base with an overhanging portion overhanging a portion of the electric vehicle.

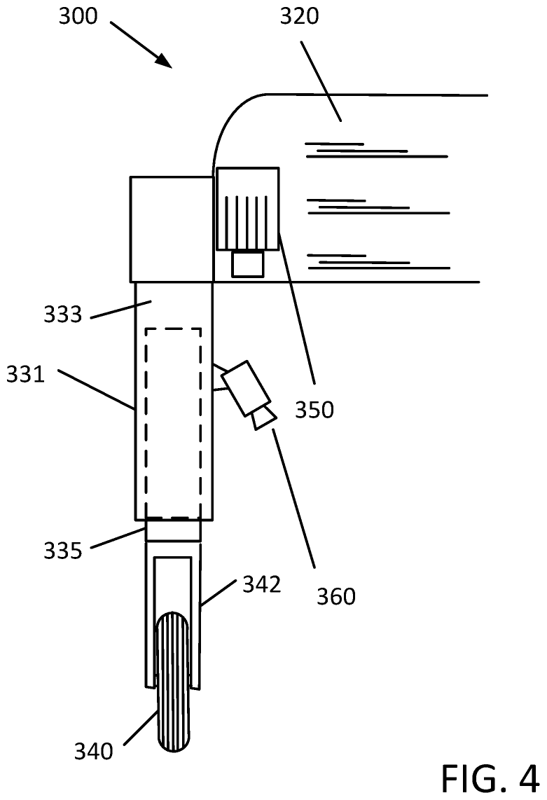

FIG. 4 illustrates a portion of an autonomous vehicle equipped with a charging system, including an extendable elongated leg configured to be extended in a vertical direction in a retracted state. Autonomous vehicle 300 is illustrated including suspended body 320 connected to extendable elongated leg 331. Extendable elongated leg 331 include an upper portion 333 and a lower portion 335. Lower portion 335 fits within upper portion 333 and is configured to retract into and extend downward there from. Extension and retraction of lower portion 335 may be accomplished by connection of an electric machine or motor, by connection of an electric solenoid, by connection of a hydraulic actuator, or by other devices in the art configured to selectively extend and retract a support member. Wheel fixture 342 is attached to an end of lower portion 335 and contains wheel 340. Sensor 360 is illustrated in a position to capture information about an electric vehicle located beneath autonomous vehicle 300.

Electric machines, electric solenoids, and hydraulic actuators may be internal to or external to the autonomous vehicles described herein. Electric machine 350 is illustrated external to autonomous vehicle 300 and is configured to turn leg 331 so as to control navigation of autonomous vehicle 300.

In the lowered state the autonomous vehicle would be more stable and as well may be like typical vehicles (with head lights and turn signals at normally accepted location as it navigates to the next customer to charge or to refill the energy storage system.)

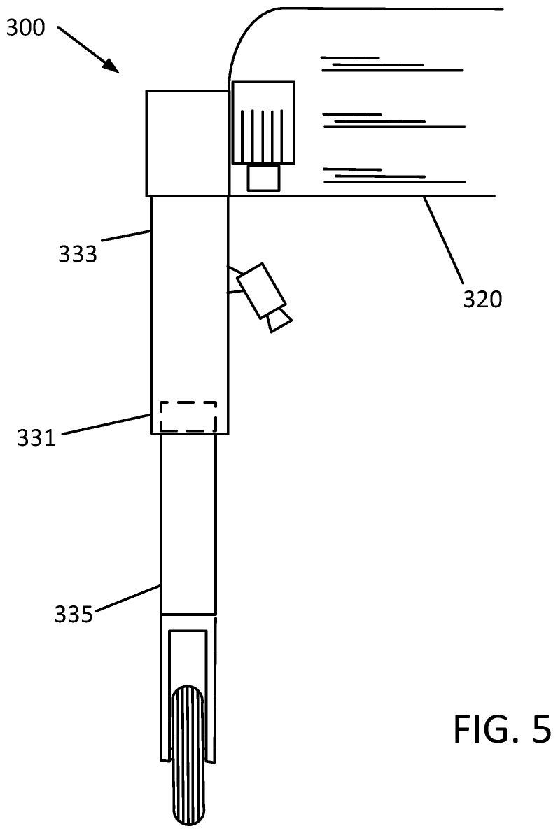

FIG. 5 illustrates the portion of the autonomous vehicle of FIG. 4, with the extendable elongated leg in an extended state. Autonomous vehicle 300 is illustrated including suspended body 320 connected to extendable elongated leg 331. Extendable elongated leg 331 includes upper portion 333 and lower portion 335, wherein lower portion 335 has been extended downward from upper portion 333.

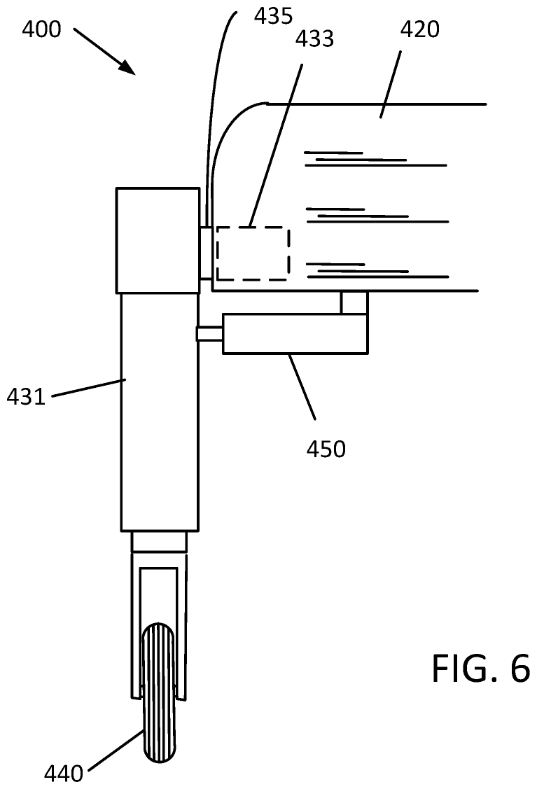

FIG. 6 illustrates a portion of an autonomous vehicle equipped with a charging system, including an extendable elongated leg configured to be extended in a vertical direction and configured to be extended in a horizontal direction, with a horizontal adjustment arm being illustrated in a retracted state. Autonomous vehicle 400 is illustrated including suspended body 420 connected to extendable elongated leg 431. Wheel 440 is attached to an end of extendable elongated leg 431. Extendable elongated leg may extend vertically similar to the leg of FIG. 4. Extendable elongated leg 431 is further equipped with a horizontal adjustment arm 435. Horizontal adjustment arm is illustrated with a portion 433 retracted within suspended body 420.

Electric machines, electric solenoids, and hydraulic actuators may be internal to or external to the autonomous vehicles described herein. Hydraulic actuator 450 is illustrated external to autonomous vehicle 400 and is configured to extend horizontal adjustment arm 435 so as to control navigation and/maneuverability of autonomous vehicle 400. Wherein a hydraulic actuator is used upon an autonomous vehicle, equipment useful to providing a pressurized flow of hydraulic fluid available in the art are additionally attached to the autonomous vehicle, for example, attached to a suspended body.

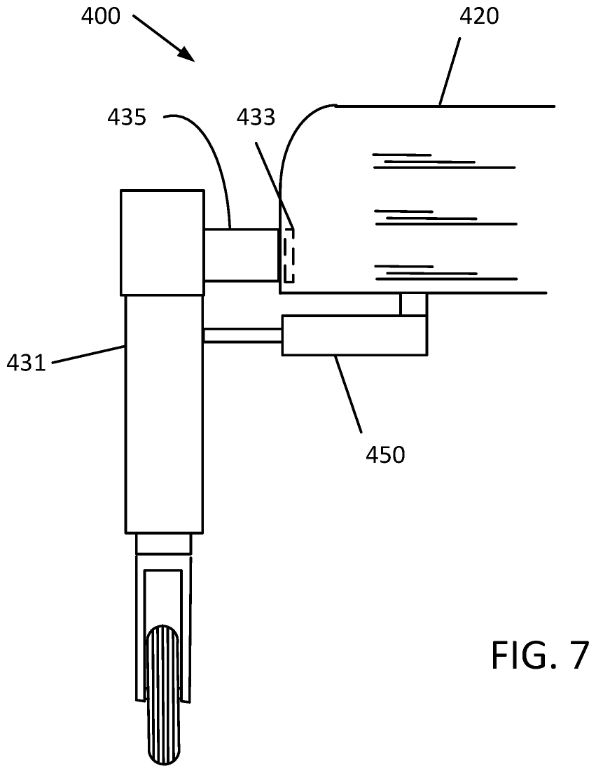

FIG. 7 illustrates the portion of the autonomous vehicle of FIG. 6, with the horizontal adjustment arm in an extended state. Autonomous vehicle 400 is illustrated including suspended body 420 connected to extendable elongated leg 431. Extendable elongated leg 431 includes horizontal adjustment arm 435, wherein a small portion 433 of horizontal adjustment arm 435 remains within suspended body 420. Horizontal adjustment arm 435 is illustrated in an extended state, with hydraulic actuator 450 providing force to move and keep horizontal adjustment arm 435 in the extended state.

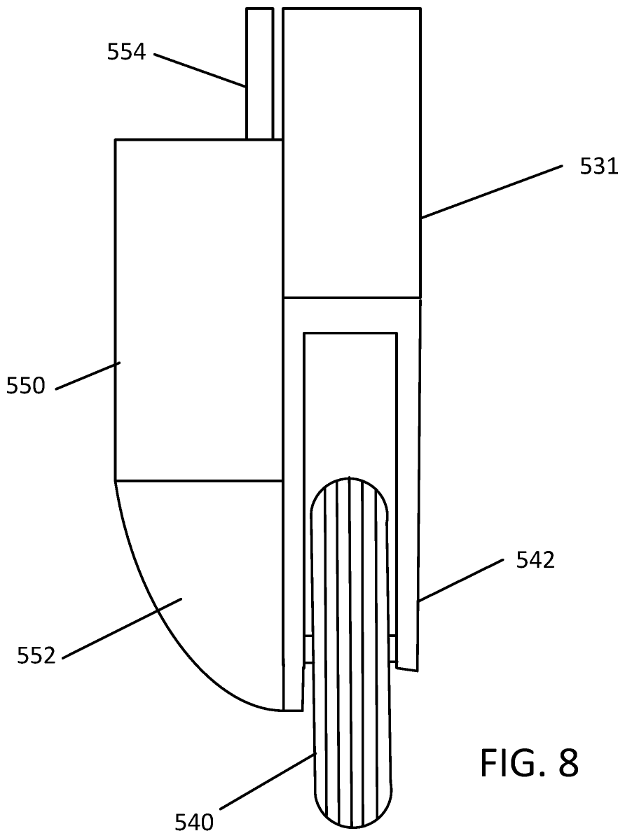

Electric machines, electric solenoids, and hydraulic actuators may be internal to or external to the autonomous vehicles described herein. FIG. 8 illustrates an exemplary wheel attached to an elongated leg of an autonomous vehicle, with an external electric machine attached to the elongated leg and providing motive force to the wheel. Elongated leg 531 is illustrated, with wheel fixture 542 attached to an end of elongated leg 531. Wheel fixture 542 contains wheel 540. Electric machine 550 is illustrated attached to an outside surface of elongated leg 531, receives power through power line 554, and provides mechanical power to gear box 552, which, in turn, provides mechanical power to wheel 540. Wheel 540 turns and provided motive force to the attached autonomous vehicle.

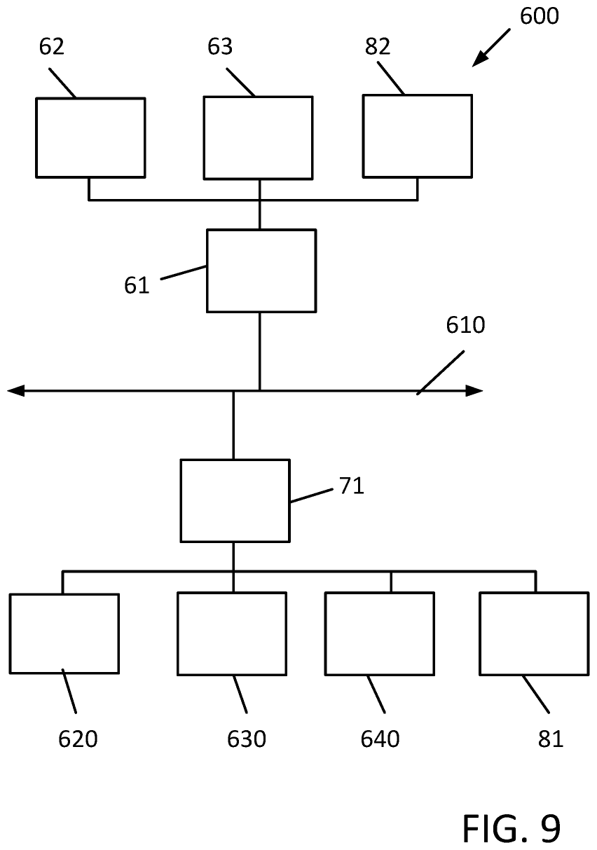

FIG. 9 illustrates an exemplary embodiment of an autonomous mobile vehicle charger system communication and control architecture. Autonomous mobile vehicle charger system communication and control architecture 600 is illustrated, including a communication bus 610 configured to provide and facilitate data communication between various components of the system. Charging control module 61 and vehicle control module 71 are illustrated, each including programming to control aspects of the system useful to accomplish the various maneuvering and charging functions and processes described herein. Charging control module 61 is illustrated in communication with fuel cell system 62, fuel cell energy storage device 63, and charging tether electric vehicle interface 82, monitoring information for the attached devices and providing signal control and power distribution commands thereto. Vehicle control module 71 is illustrated in communication with vehicle navigation machines 620, leg extension and retraction devices 630, navigation and proximity sensors 640, and charging tether articulating arm 81. Vehicle navigation machines 620 include electric machines and other devices that control movement and maneuvering of the autonomous vehicle within a parking structure, on a parking lot, or in another environment needed to perform its functions. Leg extension and retraction devices 630 include hydraulic, electrical, or other control devices useful to selectively extend and retract legs of the autonomous vehicle. Navigation and proximity sensors 640 include camera, radar, LIDAR, ultrasonic, and/or other similar sensor devices arrayed around and under the autonomous vehicle to enable the vehicle to maneuver around parked vehicles, avoid moving vehicles, pedestrians, and other obstacles, and maneuver into place to charge one or more vehicles. While charging control module 61 and vehicle control module 71 are illustrated each in direct communication with several devices, it will be appreciated that some of the devices may instead be illustrated in communication with communication bus 610 and that a majority of communication may occur through communication bus 610.

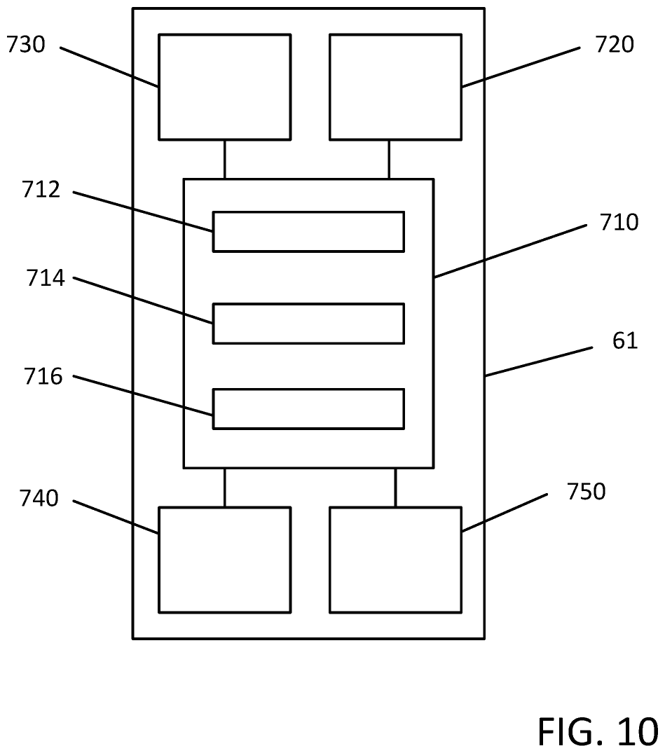

FIG. 10 illustrates an exemplary charging control module including a computerized processor operating the disclosed fuel cell stack thermal management system. Charging control module 61 may include processing device 710 configured to operate computerized programming. In the illustrative embodiment illustrating optional features of the disclosed system, charging control module 61 includes processing device 710, a control interface 730, a communications device 720, a memory device 750, a global positioning system (GPS) 740. It is noted that charging control module 61 may include other components and some of the components are not present in some embodiments.

The processing device 710 may include memory, e.g., read only memory (ROM) and random-access memory (RAM), storing processor-executable instructions and one or more processors that execute the processor-executable instructions. In embodiments where the processing device 710 includes two or more processors, the processors may operate in a parallel or distributed manner. Processing device 710 may execute the operating system of the charging control module 61. Processing device 710 may include one or more modules executing programmed code or computerized processes or methods including executable steps. Illustrated modules may include a single physical device or functionality spanning multiple physical devices. In the illustrative embodiment, the processing device 710 also fuel cell operation module 712, charging cycle module 714, and vehicle control module coordination module 716 which are described in greater detail below.

The control interface 730 is a device that allows a user to interact with the charging control module 61. While one control interface 730 is shown, the term “user interface” may include, but is not limited to, a touch screen, a physical keyboard, a mouse, a microphone, a speaker, and other user interface devices in the art.

The communications device 720 may include a communications/data connection with a vehicle bus device configured to transfer data to different components of the system and may include one or more wireless transceivers for performing wireless communication.

The memory device 750 is a device that stores data generated or received by the charging control module 61. The memory device 750 may include, but is not limited to, a hard disc drive, an optical disc drive, and/or a flash memory drive.

The GPS 740 determines a location of the charging control module 61 by communicating with a plurality of GPS satellites. The GPS 740 may perform triangulation techniques to determine the GPS coordinates of the charging control module 61. It should be appreciated that while a GPS 740 is shown, other suitable component or device useful in the art for determining a location of the system such as by cell phone tower signal triangulation may be implemented.

According to one exemplary embodiment of the disclosure, methods and processes of the disclosed system may be executed by a remote server device in communication with the charging control module 61 and other resources over a communications network, such as the Internet. Fuel cell operation module 712 includes programming configured to enable and control operation of an onboard fuel cell which converts hydrogen fuel or a similar fuel into electrical energy useful to charge electric vehicles. In some embodiments, the fuel cell may be controlled to charge an electric vehicle directly. In other embodiment, the fuel cell may be controlled to charge an onboard fuel cell energy storage device which may then be used to charge an electric vehicle.

Charging cycle module 714 includes programming configured to enable and control operation of a charging cycle of an electric vehicle which the autonomous vehicle has attached to. Charging cycle module 714 commands transfer of power from the autonomous vehicle to the electric vehicle and may monitor the energy storage device of the electric vehicle to determine when to terminate the charging cycle.

Vehicle control module coordination module 716 exchanges data with the onboard vehicle control module and may provide details such as hydrogen fuel stock remaining so that a determination may be made regarding when the autonomous vehicle needs to be refilled.

Charging control module 61 is provided as an exemplary computerized device capable of executing programmed code to operate the fuel cell and related electric vehicle charging operations. A number of different embodiments of charging control module 61, devices attached thereto, and modules operable therein are envisioned, and the disclosure is not intended to be limited to examples provided herein.

Vehicle control module 71 of FIG. 1 is similar in architecture and operation to the charging control module 61 of FIG. 9, with the exception that, in place of fuel cell operation module 712, charging cycle module 714, and vehicle control module coordination module 716, vehicle control module 71 operates a vehicle navigation and maneuvering module, a charging program coordination module, and a charging control module coordination module.

The vehicle navigation and maneuvering module of the vehicle control module includes programming configured to monitor sensor data and control movement and extension and retraction of the various portions of the autonomous vehicle in order to move the autonomous vehicle into an appropriate location to charge one or more electric vehicles.

The charging program coordination module of the vehicle control module includes programming configured to enable the vehicle to know which vehicles in a parking structure to charge. According to one example, a person parking an electric vehicle may register at an automated kiosk at the parking structure and request that the vehicle be recharged. The kiosk may then provide details regarding the electric vehicle to be recharged to the charging program coordination module of the vehicle control module. In another embodiment, a user may subscribe on the Internet to a charging program operated by the company that operates the autonomous vehicle or the parking structure. The charging program coordination module of the vehicle control module may be in communication with a remote computerized server device of the company and acquire information about the vehicle to be charged.

The charging control module coordination module of the vehicle control module exchanges data with charging control module, for example, scheduling activation the fuel cell when charging an electric vehicle is foreseeable and deactivating the fuel cell when no charging is foreseeable.

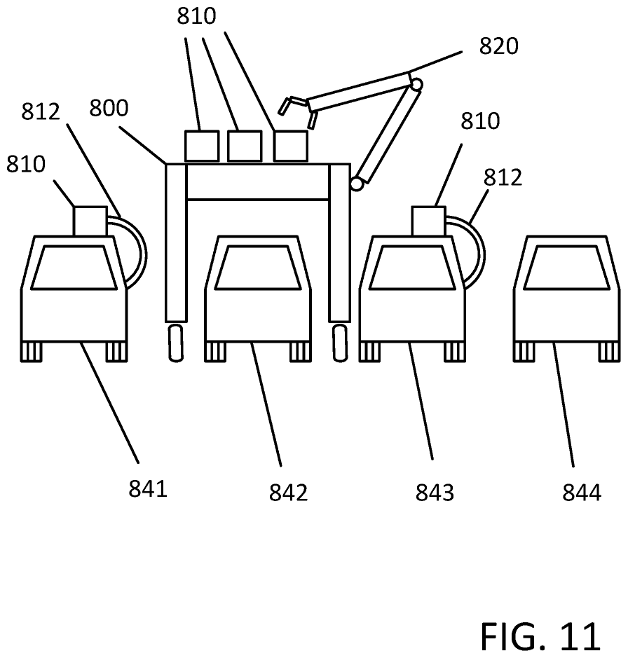

Components of the charging system may be attached to the suspended body of an autonomous vehicle in accordance with the present disclosure. A plurality of charging systems may be present upon a single autonomous vehicle, for example, to permit the autonomous vehicle to charge multiple nearby vehicles at one time. In another embodiment, charging systems may be detachable from the autonomous vehicle, and the autonomous vehicle may deploy the separable charging systems to a plurality of vehicles. FIG. 11 illustrates an autonomous vehicle deploying a plurality of separable charging systems, the charging systems each being configured to provide power to charge an electric vehicle. Autonomous vehicle 800 is illustrated, including elongated legs configured to permit the autonomous vehicle to access closely packed parked vehicles. A plurality of separable charging systems are stored upon a suspended body of autonomous vehicle 800. A deployment arm 820 of autonomous vehicle 800 is illustrated. Vehicle 841, vehicle 842, vehicle 843, and vehicle 844 are illustrated. Autonomous vehicle 800 has installed separable charging systems 810 including charging tethers 812 to vehicle 841 and vehicle 843. Autonomous vehicle 800 is illustrated in the process of deploying a separable charging system 810 to vehicle 842. In this way, a single autonomous vehicle may provide a charging service to several vehicles at one time. Separable charging system 810 is configured to separate from the autonomous vehicle and remain with the electric vehicle being charged through a charging cycle. In one embodiment, separable charge systems 810 may be configured to charge an electric vehicle through magnetic induction, eliminating the need to use charging tether 812. In another embodiment one could utilize autonomous vehicle 800 with multiple arms which extend outward with a charging tether line which plugs into vehicles on either side of autonomous vehicle 800, with an added capability to simultaneously charge vehicle 841 and 843, as an example.

The disclosed system may interface with infrastructure camera devices and other resources, for example, recognizing when a vehicle to be charged enters the parking structure and when one leaves. Similarly, data from infrastructure cameras may warn the autonomous vehicle when a driver is returning to his or her vehicle or when the autonomous vehicle needs to move for the convenience of a patron.

Autonomous vehicle sensors may be used to prevent the autonomous vehicle from approaching an electric vehicle if there are occupants inside. Similarly, if a person returns to their vehicle in a middle of a charging cycle, the system may be programmed to immediately end the charging cycle and return the vehicle to a drivable state.

It will be appreciated that some of the sensors array around the disclosed autonomous vehicle may be used to deter theft in a parking structure in which it is operating. Signs may be posted warning would-be thieves that their image is likely to be captured by the autonomous vehicles within the structure. Communication between the autonomous vehicle and a remote computerized server device may be utilized to alert authorities to suspicious behavior.

Embodiments of the disclosure are provided as an autonomous charging device. Alternative embodiments of the disclosure can include some manually operated operations of the device, including a push/puller where a garage attendant with sensor assist could place the unit over vehicle and maybe manually fill hydrogen and plug in charge cord. In one embodiment, the device may be mounted on and deployed on a guided rail or a beam, such as an overhead I-beam. Such a unit would be less expensive to purchase and operate and could be part of a valet service.

While the best modes for carrying out the disclosure have been described in detail, those familiar with the art to which this disclosure relates will recognize various alternative designs and embodiments for practicing the disclosure within the scope of the appended claims.

1. A system for charging an electric vehicle, the system comprising:
an autonomous vehicle including:
a suspended body;
a plurality of elongated legs configured to enable the autonomous vehicle to maneuver around obstacles in a parking structure and to enable the suspended body to be suspended over the electric vehicle;
a charging system configured to charge the electric vehicle; and
a plurality of sensors configured to acquire data regarding an environment around the autonomous vehicle;
wherein the autonomous vehicle comprises programming to utilize the data regarding the environment around the autonomous vehicle to automatically move to the electric vehicle.

2. The system of claim 1, wherein the charging system comprises:
a hydrogen tank; and
a fuel cell to convert hydrogen fuel from the hydrogen tank into energy to charge the electric vehicle.

3. The system of claim 2, wherein the charging system further comprises an energy storage device.

4. The system of claim 1, wherein the charging system comprises an energy storage device.

5. The system of claim 1, wherein the plurality of elongated legs are selectively extendable and selectively retractable in a vertical direction.

6. The system of claim 5, wherein the plurality of elongated legs are selectively extendable and selectively retractable in a horizontal direction.

7. The system of claim 1, wherein the plurality of elongated legs are selectively extendable and selectively retractable in a horizontal direction.

8. The system of claim 1, wherein the autonomous vehicle further comprises a charging tether articulating arm configured to connect the charging system to the electric vehicle.

9. The system of claim 8, wherein the autonomous vehicle further comprises a plurality of charging tether articulating arms configured to connect the charging system to a plurality of electric vehicles.

10. The system of claim 1, wherein the autonomous vehicle further comprises a plurality of charging tethers configured to connect the charging system to a plurality of electric vehicles.

11. The system of claim 1, wherein the charging system comprises a separable charging system configured to separate from the autonomous vehicle and remain with the electric vehicle through a charging cycle; and
wherein the autonomous vehicle comprises a deployment arm.

12. The system if claim 11, wherein the autonomous vehicle further comprises a plurality of separable charging systems.

13. The system of claim 1, wherein the plurality of elongated legs comprises two elongated legs; and
wherein the autonomous vehicle further comprises programming to maintain a center of gravity of the autonomous vehicle above a center of the two elongated legs.

14. A system for charging an electric vehicle, the system comprising:
an autonomous vehicle comprising:
a suspended body;
a plurality of elongated legs configured to enable the autonomous vehicle to maneuver around obstacles in a parking structure and to enable the suspended body to be suspended over the electric vehicle and wherein the plurality of elongated legs are selectively extendable and selectively retractable in a vertical direction;
a charging system configured to charge the electric vehicle;
a plurality of sensors configured to acquire data regarding an environment around the autonomous vehicle; and
a charging tether articulating arm configured to connect the charging system to the electric vehicle;
wherein the autonomous vehicle includes programming to utilize the data regarding the environment around the autonomous vehicle to automatically move to the electric vehicle.

15. The system of claim 14, wherein the charging system comprises:
a hydrogen tank; and
a fuel cell to convert hydrogen fuel from the hydrogen tank into energy to charge the electric vehicle.

16. (canceled)

17. The system of claim 14, wherein the charging system comprises an energy storage device.

18. A method for charging an electric vehicle, the method comprising:
within an autonomous vehicle comprising a suspended body and configured to maneuver around obstacles in a parking structure:
monitoring a plurality of sensors acquiring data regarding an environment around the autonomous vehicle;
maneuvering the autonomous vehicle based upon the data from the plurality of sensors such that the suspended body of the autonomous vehicle is over the electric vehicle; and
utilizing a charging tether articulating arm to connect the autonomous vehicle to the electric vehicle.

19. The method of claim 18, wherein the autonomous vehicle is equipped with a plurality of elongated legs, wherein the elongated legs are selectively extendable and selectively retractable in a vertical direction; and
further comprising retracting the elongated legs when the autonomous vehicle is moving to the electric vehicle.

20. The method of claim 19, further comprising extending the elongated legs when the autonomous vehicle is approaching the electric vehicle.

21. The method of claim 18, wherein the autonomous vehicle is mounted on a rail.
